(19) United States
(12) Patent Application Publication
(10) Pub. No.: US 2007/0298870 A1
(43) Pub. Date: Dec. 27, 2007

(54) GAME METHOD AND SYSTEM

(75) Inventor: Minos Paterakis, Hughesdale (AU)

Correspondence Address: KNOBBE MARTENS OLSON & BEAR LLP, 2040 MAIN STREET, FOURTEENTH FLOOR, IRVINE, CA, 92614, US

(73) Assignee: Ticketway Pty Ltd., Brunswick (AU)

(21) Appl. No.: 11/765,979

(22) Filed: Jun. 20, 2007

(30) Foreign Application Priority Data
Jun. 21, 2006 (AU) 2006100529

(51) Int. Cl. G06F 17/00

(52) U.S. Cl. 463/25; 463/42

(57) ABSTRACT

A system for providing a game or competition, comprising a computer system in electronic communication with a telecommunications network, a plurality of tokens each with an identifier, and a communication device for making an announcement that identifies a winning participant in the game or competition, the winning participant being selected from participants in the game or competition. The identifiers are adapted for entry into an electronic device and for transmission from the electronic device to the computer system, the computer system is configured to receive the identifiers, and the participants are those people who enter their identifier into their respective electronic devices and who transmit their respective identifiers to the computer system.

### RELATED APPLICATION

This application claims the benefit of Australian patent no. 2006100529 filed Jun. 21, 2006, the content of which is incorporated herein by reference in its entirety.

### FIELD OF THE INVENTION

The invention relates to a game method and system, of particular but by no means exclusive application at or during public events (such as sporting fixtures or concerts).

### BACKGROUND OF THE INVENTION

One existing method for playing a game or participating in a competition includes transmitting one's personal or contact details to the game or competition organizer from one's mobile telephone by means of, for example, the short messaging service (SMS). This approach may be regarded as a more recent development of the more longstanding and widely employed approach of posting an entry for a game or competition to the organizer by mail.

### SUMMARY OF THE INVENTION

The invention provides, therefore, a system for providing a game or competition, comprising:
a computer system in electronic communication with a telecommunications network (which may be wireless, such as a mobile telephony network, or otherwise);
a plurality of tokens (such as for admitting patrons to an event, fixture or venue) each with an identifier (that will typically but not always be unique to a respective token); and
a communication device for making an announcement that identifies a winning participant in said game or competition, said winning participant being selected from participants in said game or competition;
wherein said identifiers are adapted for entry into an electronic device (such as a mobile telephone, a personal digital assistant (PDA) or a pager) and for transmission from said electronic device to the computer system, said participants are those people who enter their identifier into their electronic device and transmit their identifier to the computer system, and the computer system is configured to receive (and possibly store) said identifiers.

In a particular embodiment, the telecommunications network is a wireless telecommunications network (that is, has at least a portion that is wireless), and the electronic device is a mobile device, such as a mobile telephone or a PDA.

The tokens would typically be admission tickets to a fixture or other event, but could be issued separately thereto. The tokens may comprise a plurality of portions (integral or otherwise), such as with one portion sufficient to gain admission to a fixture or other event and another portion bearing the identifier.

In practice, the participants will typically transmit their identifier to a telephone number (or the like, such an email address), such that the identifiers (which may then be regarded as “entries”) being ultimately routed to the computer system.

The communication device may comprise a screen on which can be displayed the announcement, in the form of the identifier received from the selected winning participant, so that the holder of the ticket bearing that identifier is made aware that they are entitled to claim a prize.

In some embodiments, the electronic device—in transmitting the identifier—also transmits data that identifies the electronic device or the owner of the electronic device. In such embodiments, the announcement may include the identity of the electronic device or its owner. The announcement may be, again, displayed on the communication device; alternatively, the communication device may be in electronic communication with the telecommunications network, and configured to transmit the announcement directly to (at least) the winning participant.

It will be appreciated that the identifiers will typically be transmitted as data indicative of the identifiers, but suitable for reconstitution—possibly in encoded form—in the computer system, without falling outside the scope of this aspect of the invention.

The identifier may be alphanumeric and readable by the person (such as a ticket number), so that the person may manually enter the identifier into the electronic device, such as into an SMS input screen provided by the electronic device. Alternatively, the identifier may be machine readable, and adapted to be read by the electronic device.

It will be appreciated that the telecommunications network may be wired, unwired or a mixture of both, as is typically the case with a telephone network that carries telephony in part wirelessly, in part over copper wire, and in part by optical fibre.

The invention also provides, in another aspect, a game or competition method, comprising:
providing a plurality of tokens (such as for admitting patrons to an event, fixture or venue) with a respective unique identifier;
receiving data indicative of one or more of said identifiers via a telecommunications network (such as a mobile telephony network) from one or more electronic devices;
selecting an identifier from the received identifiers;
deeming the token associated with the selected identifier or the bearer of the token associated with the selected identifier to be the winning token or person; and
announcing the selected identifier, the winning token or the winning person.

The method may include receiving said data indicative of one or more of said identifiers into a computer system in electronic communication with the telecommunications network.

The method may include making the announcement to the mobile electronic device from which the selected identifier was received.

The method may include selecting the winning identifier either manually or automatically.

The method may include charging a participant in the game or competition via an electronic device account (such as a mobile telephony account). The method may include passing a first portion of the charge to the electronic device provider and a second portion of the charge to the provider of the game or competition.

### BRIEF DESCRIPTION OF THE DRAWINGS

In order that the invention may be more clearly ascertained, embodiments will now be described, by way of example, with reference to the accompanying drawings, in which:

FIG. 1 is a schematic view of a competition system according to one embodiment of the invention; and

FIG. 2 is a flow diagram of the operation of the competition system of FIG. 1.

### DETAILED DESCRIPTION

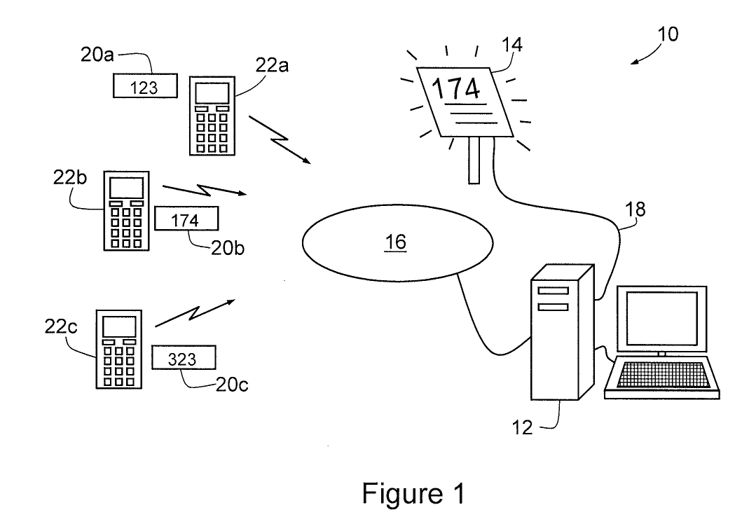

A competition system according to an embodiment of the invention is generally at 10 in FIG. 1.

The system 10 includes a computer system comprising competition server 12 and a communication device in the form of display screen 14. The server 12 is connected to a mobile telephony network 16 and consequently can receive short messaging service (SMS) messages sent from mobile telephones. Server 12 and display screen 14 are in communication with each other via communications link 18 (typically a landline, though optionally at least in part a wireless link), so that server 12 can control display screen 14 to display announcements (as is described below).

The system 10 also includes a plurality of tokens in the form of admission tickets 20a, 20b, 20c. The system is adapted to be used at public events, such as a concert or sport event, so it will be appreciated that the number of tickets may be far higher, and is typically limited only by the capacity of the venue or ground. Hence, the system may commonly include thousands or tens of thousands of such tickets.

Each ticket 20a, 20b, 20c bears a unique identifier in the form of a ticket number. In this embodiment, the identifier is the usual ticket number, but in other embodiments the identifier may be an additional number printed on the ticket, or a portion (such as the last five digits) of the ticket number.

Also, in some other embodiments, the identifier may not be unique. For example, the identifier might be deemed to be the last two digits of a ticket number with five digits. There may then be multiple ultimate winners, possibly awarded different prizes according to the order in which the entries are received. It may be announced, for example, that the first winner will receive the most valuable prize, to encourage people to enter the competition. In these embodiments, the participants would not be told that only the last two digits will be used; they would thus submit their entire ticket number so that it could be checked to be a valid ticket number.

Though not forming a part of the system 10, FIG. 1 also includes mobile telephones 22a, 22b, 22c, in the respective possession of the bearers of respective tickets 20a, 20b, 20c.

The system 10 allows the bearers of mobile telephones 22a, 22b, 22c (and of respective tickets 20a, 20b, 20c) users to participate in a competition during the concert or event at which the system 10 is used and to which the bearers of tickets 20a, 20b, 20c gained admission with the tickets. In use, the bearers of tickets 20a, 20b, 20c use their mobile telephones 22a, 22b, 22c to transmit, by means of SMS, their respective ticket numbers to an advertised telephone number (e.g. 1800 123 456). All such entries are recorded. In this embodiment, the rules of the competition dictate that entries can validly be received only during the duration of the concert or game (though other valid periods could be stipulated, such as “before half time”).

At a predetermined time after the period for validly submitting entries has closed (such as during a half time break in the concert or game), a winning ticket number is selected and transmitted from server 12 to screen 14, and displayed to the audience at the concert or game.

The ticket number can be selected manually or automatically, whether according to some predetermined criterion or randomly. In this embodiment, however, it is generated by server 12 by random number generation. Random number generation can be used in any other suitable way, known to those in the art, to select the winning ticket number. For example, random numbers of the appropriate number of digits (to match the number of digits in the ticket numbers) may be generated until the number so generated matches a received ticket number. However, in this embodiment, random number generation is used to select a received SMS entry; the ticket number in the selected SMS is checked for validity. If valid, that ticket number is deemed the winning ticket number. Otherwise the selection process is repeated until an SMS entry containing a valid ticket number is selected.

The screen 14 also announces how the bearer of the ticket corresponding to the winning ticket number can collect their prize.

Each participant in the competition is charged via their mobile telephony provider at a premium rate. The charge includes a first portion (that pays the provider for the use of the SMS facility) and a second portion that the mobile telephone provider passes on to the provider of the system 10. The first portion may be approximately 10% of the total charge, but the precise figure will be the subject of negotiation between the parties (including mobile telephone provider and the provider of the system 10), and depend on commercial considerations. By this mechanism, the provider of the system 10 obtains revenue from the provision of the competition.

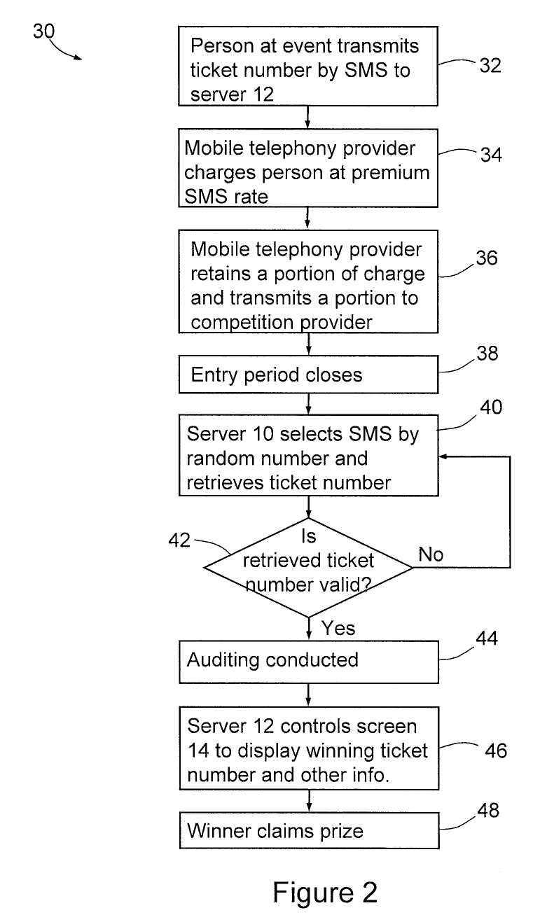

FIG. 2 is a flow diagram 30 of the operation of the competition system of FIG. 1. The operation of the system includes the following steps. At step 32, a person attending the concert or game transmits the ticket number on their ticket, by SMS, to server 12 (which records this and all other submitted entries). At step 34, the mobile telephony provider of the person charges the person at a premium SMS rate. At step 36, the mobile telephony provider retains a first portion of that charge and transmits a second portion to the competition provider.

At step 38, the period in which entries can validly be received by the server 12 closes.

At step 40, the server 10 selects a received SMS entry by random number generation and retrieves the ticket number contained in the SMS message. At step 42, the server 12 checks whether the retrieved ticket number is valid (that is, corresponds to a ticket for the instant concert or game). If not, processing returns to step 40, where a received SMS entry is again selected by random number generation.

If the retrieved ticket number is valid, which means that a winning ticket number has been selected, processing proceeds to step 44 where auditing of the process is conducted, and relevant data is saved for later inspection (if this should prove necessary).

At step 46, the server 12 controls the screen 14 to display the winning ticket number and other information (such as how the winner can collect their prize). At step 48, the winner claims his or her prize by attending a predetermined location, proving his or her identity by presenting their ticket with the winning ticket number and either collecting their prize or providing their contact details so that the prize can be sent to them (such as by cheque).

Modifications within the scope of the invention may be readily effected by those skilled in the art. It is to be understood, therefore, that this invention is not limited to the particular embodiments described by way of example hereinabove.

Further, any reference herein to prior art is not intended to imply that such prior art forms or formed a part of the common general knowledge.

1. A system for providing a game or competition, comprising:
a computer system in communication with a telecommunications network;
a plurality of tokens each associated with an identifier; and
a communication device configured to communicate an announcement that identifies a winning participant in said game or competition, said winning participant being selected from participants in said game or competition,
wherein identifiers are adapted for entry into an electronic device and for transmission from said electronic device to the computer system, said computer system being configured to receive said identifiers, and said identifiers are entered via respective user interfaces into respective electronic devices and are transmitted to the computer system.

2. The system as claimed in claim 1, wherein said tokens comprise admission tickets that provide a right of admission to an event, fixture or venue.

3. The system as claimed in claim 2, wherein said participants gain admission to said event, fixture or venue with respective admission tickets, and said identifiers are entered into respective electronic devices, and are transmitted to the computer system.

4. The system as claimed in claim 1, wherein said telecommunications network is a wireless telecommunications network, and said electronic device is a mobile device.

5. The system as claimed in claim 1, wherein said identifier is a number.

6. The system as claimed in claim 1, wherein said identifier is not unique.

7. The system as claimed in claim 1, wherein said winning participant is one of a plurality of winning participants.

8. A method, comprising:
providing a plurality of tokens with respective identifiers;
receiving data indicative of one or more of said identifiers via a telecommunications network from one or more electronic devices;
selecting an identifier from the received identifiers;
determining the token associated with the selected identifier or the bearer of the token associated with the selected identifier to be the winning token or person; and
announcing the selected identifier, the winning token or information identifying the winning person.

9. The method as claimed in claim 8, wherein said tokens comprise admission tickets that provide a right of admission to an event, fixture or venue.

10. The method as claimed in claim 9, further comprising selecting an identifier from the received identifiers that correspond to admission tickets that have been used to gain admission to said event, fixture or venue.

11. The method as claimed in claim 8, wherein said identifiers are unique.

12. The method as claimed in claim 8, wherein announcing the selected identifier, the winning token or the winning person comprises making said announcement to the electronic device from which the selected identifier was received.

13. The method as claimed in claim 8, wherein said identifiers are not unique.

14. The method as claimed in claim 8, wherein determining comprises determining a plurality of tokens associated with the selected identifier or a plurality of bearers of the tokens associated with the selected identifier to be the winning tokens or persons.

15. A token for use in a game or competition, comprising:
an identifier adapted for entry into an electronic device and for transmission from said electronic device to a computer system, the computer system being configured to receive said identifier and select a winning participant from participants in said game or competition, said identifiers are entered into respective electronic devices and transmitted to said computer system.

16. The token as claimed in claim 15, wherein said token comprises an admission ticket that provides a right of admission to an event, fixture or venue.

17. The token as claimed in claim 15, wherein said identifier is not unique to said token.

18. The token as claimed in claim 15, wherein said winning participant is one of a plurality of winning participants.

19. A gaming system, comprising:
a plurality of tokens comprising identifiers;
a computing system configured to receive data indicative of one or more of said identifiers via a telecommunications network from one or more electronic devices, select an identifier from the received identifiers, determine the token associated with the selected identifier or the bearer of the token associated with the selected identifier to be the winning token, and display the selected identifier, the winning token or information identifying the bearer of the winning token.
